(19) United States
(12) Patent Application Publication
(10) Pub. No.: US 2010/0299178 A1
(43) Pub. Date: Nov. 25, 2010

(54) Method and system for contacting a prospect or requestor immediately after a request for product information

(76) Inventor: Ilya Abezgauz Druzhnikov, Portola Valley, CA (US)

Correspondence Address: ELLIOT FURMAN, 15 WEST 81ST STREET #11J, NEW YORK, NY, 10024, US

(21) Appl. No.: 12/719,731

(22) Filed: Mar. 8, 2010

Related U.S. Application Data
(60) Provisional application No. 61/157,964, filed on Mar. 6, 2009.

(51) Int. Cl. G06Q 10/00; G06Q 30/00; G10L 15/26

(52) U.S. Cl. 705/9; 705/26.61; 704/235; 704/E13.001

(57) ABSTRACT

A product information request is received via of the internet by way of a webform. The webform is parsed to extract requestor information which includes information about the product and the requestor. A database of salespeople is queried to find the most appropriate salespeople to be called based on the product request and requestor's information. These salespeople are called until one of them answers. Upon answering, the requestor's information is spoken to the salesperson by electronically converting text to speech, and the salesperson is placed on hold. Around this time, the requestor is called. The salesperson can hear the requestor being called. When the requestor answers, the salesperson's hold is removed and the salesperson and requestor can speak.

This application claims the benefit of U.S. Provisional Application No. 61/157,964 filed Mar. 6, 2009, which is hereby incorporated by reference.

This application is related to U.S. patent application Ser. No. 12/330,223 filed Dec. 8, 2008 which claims the benefit of U.S. Provisional Application No. 61/012,117 filed Dec. 7, 2007 and U.S. Provisional Application No. 61/114,414, filed Nov. 13, 2008, all of which are hereby incorporated by reference.

This application is also related to U.S. patent application Ser. No. 11/556,301 filed Nov. 3, 2006 which claims the benefit of U.S. Provisional Application No. 60/732,993 filed Nov. 3, 2005 and U.S. Provisional Application No. 60/811,571, filed Jun. 6, 2006, all of which are hereby incorporated by reference.

### BACKGROUND

It is commonplace to provide online information about products for sale and services offered (the words “product” or “products” are defined henceforth to include anything for sale or offered, including physical products or items, and intangible things such as services). Websites displaying this information often allow a person viewing the site to request more information about the product. Typically, a person interested in more information, also referred to herein as a “requestor” or “prospect,” fills out a webform (also referred to herein as a “form”) with their information such as name, email address, telephone number, company name, interest in the product, specific questions, and the like.

When the prospect submits the form, the form data is received by a server which then forwards it, for example, via email to a salesperson. Eventually, the salesperson reads the email and, in due time, calls the prospect to initiate a sales conversation.

It is well known that the probability of closing a sale decreases rapidly with the elapsed time between when the prospect requests more information and the salesperson is able to contact and speak with the prospect. It is believed that a sale is most probable if the prospect is contacted within around five minutes of requesting more information. But, after around five minutes, the probably of effectuating a sale decreases significantly. If around 20 hours have elapsed, a sale may be extraordinarily difficult.

Thus, a need exists for a system and method for contacting a prospect or requestor immediately after receiving a request for product information. A need also exists for a system and method for contacting a salesperson in the field when the prospect or requestor is contacted.

### SUMMARY

A method for contacting a prospect or requestor immediately after receiving a request for product information comprises electronically receiving a request for product information. The request is parsed to extract requestor information, wherein the requestor information comprises lead data. A salesperson is called according to the lead data. If the salesperson does not answer a different salesperson is called until a salesperson answers. If a salesperson answers, at least some of the lead data is electronically communicated to the salesperson. The salesperson is placed on hold. The prospect is called at a number received from the extracted requestor information. If the prospect answers the call, the salesperson and the requestor are connected so that they can speak.

### BRIEF DESCRIPTION OF THE DRAWINGS

FIG. 1 is a method for contacting a prospect or requestor immediately after a request for product information.

FIG. 2 is a system for contacting a prospect or requestor immediately after a request for product information.

FIG. 3 is a method for toggling the availability of a salesperson to receive sales calls when a prospect or requestor is available.

### DETAILED DESCRIPTION

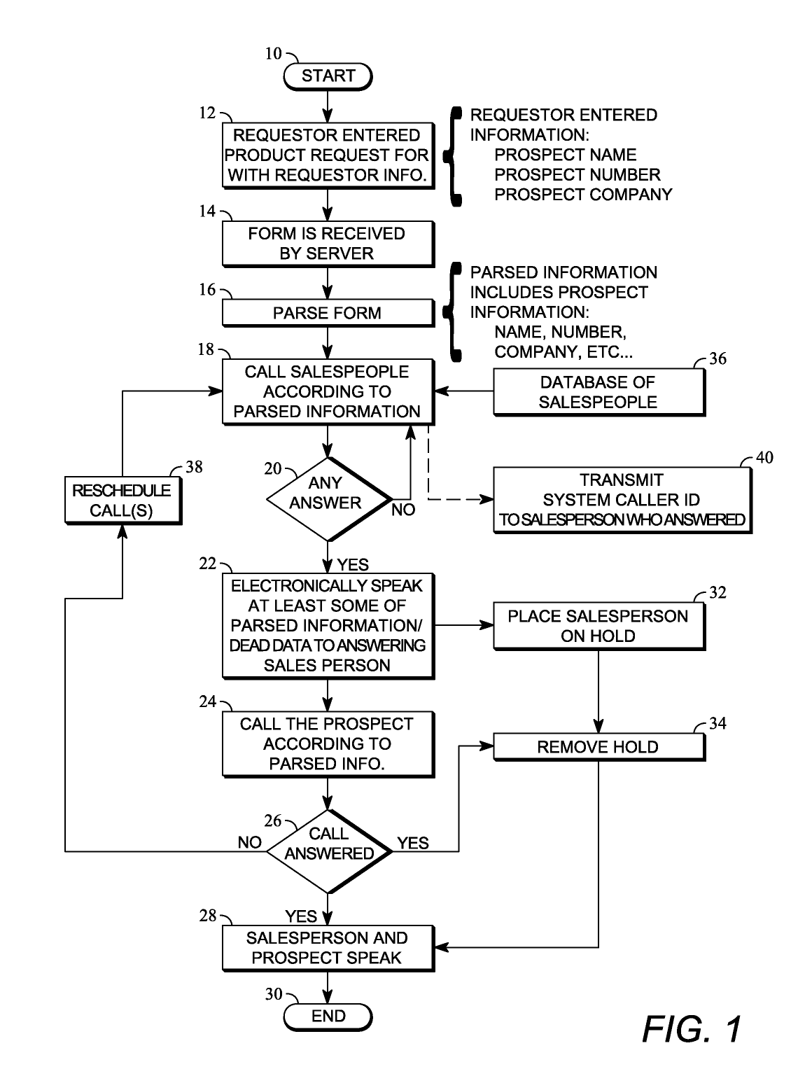

FIG. 1 is a method for contacting a prospect or requestor immediately after a webform request for product information. The method starts 10 after a requestor or prospect has decided to request information about a product. The requestor or prospect is presented with a product request form, such as a webform, into which he may enter information specific to his request. Webforms are well understood by those having ordinary skill in the art.

It is appreciated that, in some cases, a requestor may be different from a prospect. For example, the requestor may be an assistant who is requesting information on behalf of a superior. In that case the requestor is the assistant who provides the information in the form, but the prospect is the person who should be contacted. Notwithstanding this subtle distinction the terms “requestor” and “prospect” are used interchangeably herein.

The product request form is electronically submitted 12, for example via HTTP, HTTPS, or any other communication protocol. The form includes fields for the requestor to fill, such as company name, telephone number, questions, and the like. It is understood that the telephone number may be any number used to communicate with a device such as a POTS phone, a cell phone, a smartphone, an IPHONE, a PDA, or any other communication device. In that respect, it is understood that “number” includes any electronic identifier for communicating with a device assigned that identifier, even if that “number” is not what is recognized as a conventional “telephone number.”

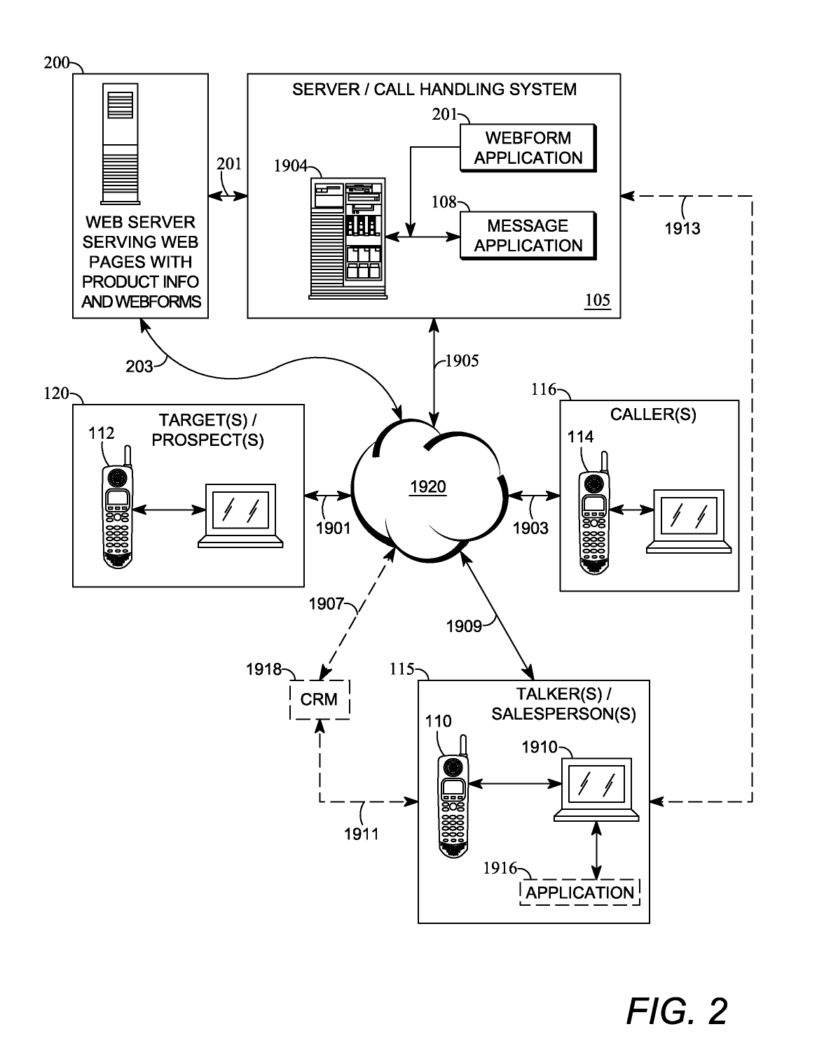

The completed form is received by a server 14. The server may include a call handling system, as will be described later with reference to FIG. 2. The form is parsed 16. In parsing the form 16, information is extracted such as the requestor information entered into the form, including for example, company name, telephone number or other electronic identifier, and product questions. This extracted information is equivalently referred to as lead data. It is appreciated that many other items of information may be parsed from the form.

In one alternative, instead of receiving the request 14 from a product request form displayed on a prospect's computer (12 of FIG. 1, and 120 of FIG. 2), the product request form is an “audible form” rather than a “visual” one. In this case, the request is received by way of an inbound phone call from the target (120 of FIG. 2) to the call handling system 105 to request more information. The target may indicate his request via an interactive voice response (IVR) system, and the step of parsing 16 includes receiving the IVR responses to extract to the lead data. The target may also speak his request and leave a message with his name, number, and other information and questions. In this case, the step of parsing 16 includes converting the speech message to text to extract the lead data.

When the requestor information is identified and stored from the step of parsing 16, salespeople are called 18 according to the parsed information, that is, the lead data. A salesperson database is provided 36. For each salesperson in the database, the database comprises contact information, such as a phone number, an availability status, and additional information. The additional information may comprise personal and professional information about the salesperson such as an assignment, a territory of responsibility, a geography of responsibility, residence, information conveying expertise and knowledge about particular products, an experience level, an education level, languages spoken, a gender, an age, an ethnicity, and the like.

In one example, only those salespeople associated with a product as set forth in the lead data are queued to be called. In another example, only those salespeople registered with the system as currently available are queued to be called. As can now be appreciated, depending on the lead data, the salesperson database can be searched for salespeople having the most appropriate skill set, profile, and availability for the product information request.

The server may select available and appropriate salespeople and call them in a serial manner, either sequentially or randomly. That is, a salesperson(s) is selected, and the server initiates an outbound call to that salesperson(s) 18. If the salesperson does not answer 20 after a period of time, for example thirty seconds, the server may select a different salesperson and make a call to that salesperson 18. This is repeated until an available salesperson answers 20.

Alternatively, the server may select more than one appropriate salesperson in the salesperson database 36 and call them simultaneously or within several seconds of each other. In selecting salespeople, the system accesses the database 36 and may select salespeople based on their assignment, on their territory, on their expertise, or based on any other rule. In this way, only the most qualified, relevant, and knowledgeable salespeople are called; the prospect is connecting with a salesperson most qualified to answer questions and most likely to make a sale.

In any case, the first salesperson to answer 20 is connected to the server, and the other salespeople, if any are simultaneously being called 18 or are queued, are disconnected from the call handling system (105 of FIG. 2) or removed from the calling queue. Algorithms such as predictive dialing algorithms may be used to call appropriate salespeople in the salesperson database 36. It is appreciated that the salesperson may be called by the call handling system (105 of FIG. 2) at a conventional POTS or wireless number, or the salesperson may be called via VoIP on a private or public network wherein the salesperson has a full time connection to the server and is using a headset, or the salesperson may be called on any voice enabled device, and the like.

Additionally, when the call is placed from the system (105 of FIG. 2) to the salesperson 18, a system caller ID is transmitted 40 to each salesperson that is called. The caller ID may be, for example, a recognizable number, or alphanumeric sequence, or word(s) indicating to the salesperson that the incoming call is from the system (105 of FIG. 2) and a prospect has requested information and will be called. In this way the salesperson knows that the call is going to be a sales call and can prepare himself accordingly.

The salesperson may control when and for how long he is connected, or registered with the call handling system 105, and thus potentially called by the system. Those salespeople registered with the server 105, and indicating that they are available, are candidates for receiving calls.

One way a salesperson registers with the server 105, and thus makes himself available to receive calls, is to call the server 105. An “availability toggle number” is provided. When that number is called by the salesperson, the availability of the salesperson to receive calls is toggled and a field in the salesperson database indicating his availability status is updated. For example, if the salesperson is not available but wishes to be available to receive calls, the salesperson dials the availability toggle number, the system receives the call, and registers the salesperson as available. When the salesperson wants to go off-line, that is not receive any calls, the salesperson calls the toggle number again, and the system toggles the registered salesperson as not available. A message or beep may be played to the salesperson indicating his availability status.

The database of salespeople comprises information about the salespeople, such as their contact information, such as a phone number(s) and electronic identifier(s), an availability status, and additional information. The additional information may comprise personal and professional information about the salesperson such as an assignment, a territory of responsibility, a geography of responsibility, residence, information conveying expertise and knowledge about particular products, an experience level, an education level, languages spoken, a gender, an age, an ethnicity, and the like. With this information, when the salesperson attempts to register himself as available, the system is able to verify the authenticity of the salesperson, for example, by requesting information from the caller. In this way a call from an unauthorized person is not given access to the system.

The system 105 makes outbound calls to all available and appropriate salespeople at one or more than one number or electronic identifier. For example, the system 105 may be configured such that the system 105 makes calls to the device from which the salesperson called the system to toggle his availability number, for example 110. Also, the system may be configured such that calls are placed from the system 105 to any device or more than one device of the salesperson (such as phone 110 and a second phone not shown in FIG. 2), simultaneously or sequentially; the salesperson may have several contact numbers stored in the database of salespeople. For example, the salesperson may want calls to be received at his cell phone and at his home phone, simultaneously. The system may be configured so that the salesperson has a schedule and is automatically made available and not available according to pre-set times.

Options and preferences such as these may be configured in many ways. For example, the salesperson may configure his preferences when he has access to an internet connected computer 1910. In this example, the salesperson logs into his account at server 1904 and modifies his preferences, which are then stored in the database. In another example, when the salesperson calls the availability toggle number, the salesperson is presented with a spoken menu of options. In this case, the salesperson uses the keypad of his phone or mobile device to input his preferences. If the call handling system 105 includes a speech recognition system, the salesperson may speak his preferences.

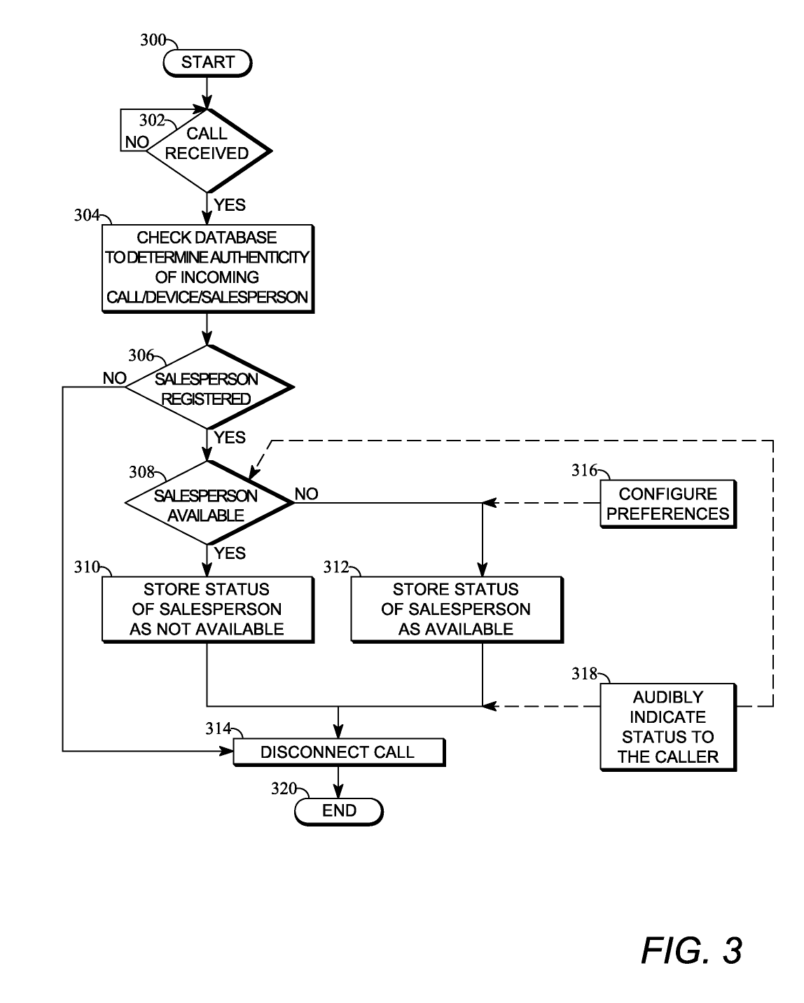

With reference to the above, FIG. 3 shows a method for toggling the availability of a salesperson to receive sales calls when a prospect is available. The method starts 300 and checks if a call has been received 300, the call being placed by a salesperson using the availability toggle number. If a call has been received, the database (36 of FIG. 1) is accessed to determine the authenticity of the incoming call 304. An electronic identifier (such as caller ID) may be compared against the database to determine authenticity. Alternatively, or in addition, the salesperson may have to enter an access code to be authenticated.

If the call is not authentic 306 (“NO” branch), the call is disconnected 314. If the call is authentic 306 (“YES” branch), that is the call is from a registered salesperson in the database, it is determined if the salesperson's current status is available or not available 308. If the salesperson's current status is available 308 (“YES” branch), the status of the salesperson is toggled to not available. The status is stored in the database. Then the call is disconnected 314 and the method ends 320.

If the salesperson's current status is not available 308 (“NO” branch), the status of the salesperson is toggled to available and stored in the database. The salesperson may optionally configure preferences 316 as described above. Next the call is disconnected 314 and the method ends 320.

As described above, the salesperson may be given some sort of audible indication as to his status. This may be done, for example after the salesperson is determined to be authentic 306, and it may be done prior to disconnecting the call 314.

Turning back to FIG. 1, After a salesperson has answered 20, the server electronically communicates at least some of the parsed information or lead data to the salesperson 22. In electronically communicating, at least some of the parsed information, or lead data, from step 16 is converted from text to speech. Speech synthesis is well understood by those having ordinary skill in the art.

In one example, the salesperson answers the call and the name, company, and product is spoken to the salesperson. For example, after parsing, if the name is “John Doe,” the company is “Acme Inc.,” and the product is a “widgets” an exemplary audio transmission spoken to the salesperson is “John Doe, from the company Acme Inc. would like more information about widgets.” Alternatively, or in addition to computer generated speech, the information and other lead data may be communicated by way of text message, instant message, email, computer executable code displayed in a web browser, a blog, a microblog, and a user interface to a CRM system. With respect to the CRM, a CRM database (1918 of FIG. 2) is accessed to find available additional lead data about the prospect.

If the salesperson is also connected and registered with the server via a client computer 115, the lead data is displayed on a the client computer 1910, including any additional lead data or information from, for example, a customer relationship management (CRM) database, or some other public or private database. Lead data is the information relating to a lead or a target, or in the present case, the prospect. Examples of lead data include names, company, phone numbers, and other identifying information.

At or around the time the salesperson is called 22 or answers 20, the server (105 of FIG. 2) calls the prospect (112 of FIG. 2) at the prospect's number 24, the number having been received from the step of parsing 16.

The time between when the form is submitted 14 and the salesperson and prospect are called (steps 22 and 24) is very short. In one example, all of these steps are carried out in less than a minute; the requestor just submits the product request form 14 and appropriate salespeople are available to speak with and connected to the prospect (18 and 36, also see FIG. 3 for toggling availability). Thus, no time is wasted by the salesperson (115 of FIG. 2) making dead-end calls, and no interest is lost by the prospect (120 of FIG. 2) due to elapsing time between a request and a reply to the request.

Returning to step 24, the prospect is called. In the event that the prospect does not answer the call 26, the call is allowed to “ring” for a specified period of time, for example 90 seconds, before it is disconnected. If the call is not answered, the call may be disconnected and, after a period of time 38, retried as described above starting with step 18. An automated or customized message may be left if the call is answered by voicemail or an answering machine.

The call may be rescheduled 38 until the prospect answers the call 26. It may also be rescheduled 38 a finite number of times, or only within a set period of time, for example three days, after which the prospect is dropped from the calling queue and the prospect is considered a dead-end lead.

In the likely event that the prospect answers the call 36, the server immediately and silently connects the salesperson and the prospect 28. Once connected, communication between the salesperson and prospect is allowed; the prospect can speak with the salesperson to learn more about the product, and the salesperson can try to effectuate a sale of the product.

Referring back to steps 22 and 24, during the time the call is being made to the prospect 24, the salesperson may be placed on hold 32. The salesperson is placed on hold 32 while the lead data is electronically communicated to the salesperson 22. During the hold 32, lead data is, for example, spoken to the salesperson. Additionally, after the lead data is spoken, the salesperson is able to hear the prospect being called. In this way, the salesperson is completely prepared as soon as the prospect answers the call.

Also, any noise or speech received by the microphone of the salesperson's headset or telephone (110 of FIG. 2) is muted while the prospect is being called 24 to eliminate any chance of the prospect hearing background noise from the salesperson. Once the call is answered 26 by the prospect, the salesperson and prospect are immediately connected by removing the hold 34 which includes, if necessary, un-muting the salesperson's microphone. Thereafter, the hold is removed 34 and the salesperson and prospect can speak freely and are connected 28.

At the end of the call 30, the salesperson may record information about the call in a local or networked database such as in a CRM system (1918 of FIG. 2).

FIG. 2 is a system for contacting a prospect immediately after a webform request for product information. The call handling system 105, prospect(s) 120, salesperson(s) 115, CRM 1918, network 1920, and all connections 1901, 1903, 1905, 1907, 1909, 1911, 1913, and any other inherent or virtual connections are as described in the following: Patent Application Publication No. US 2007/0121902 A1 published on May 31, 2007 which was filed on Nov. 3, 2006 as application Ser. No. 11/556,301, the entirety of which is hereby incorporated by reference; and patent application Ser. No. 12/330,223 filed on Dec. 8, 2008, the entirety of which is hereby incorporated by reference.

Briefly, call handling system 105 is a system for making calls, connecting, and transferring calls between multiple entities such as targets 120, callers 110, and talkers 115. The call handling system maintains or is in communication with a database of leads, or targets, and has control over the placing of calls, transfers, and any other necessary messaging. A CRM database may be in communication with one or more elements shown in FIG. 1, either directly or indirectly.

FIG. 1 also includes a web server 200. The web server 200 serves webpages via network 1920 to computers connected to the network 1920 such as targets 120. The webpages are displayed on a target's computer and the target may navigate and interact with the website. The website also includes webforms for the target 120 to request more information. In another embodiment, webforms are served from computer 1904.

The call handling system 105 includes a webform application 202. The webform application 202 includes code stored on a storage device such as a memory or hard drive. The code, when executed by a processor, such as the processor of computer 1904, causes the computer to carry out the steps of the method of FIG. 1, as detailed above. The server of call handling system 105 includes a software private branch exchange (PBX), such as ASTERISK.

Examining FIG. 2, with reference back to FIG. 1 as necessary, a prospect 120 requests product information by way of the webform served by web server 200. When the prospect 120 submits the form, the form is received by the server (step 14 of FIG. 1) as indicated by connection 201. Connection 201 does not necessarily indicate a direct connection between web server 200 and server 202. In some configurations, all signaling is though network 1920, such as the internet, and via HTTP, HTTPS, or any other equivalent protocols.

In one example, by “receiving” the form it is meant that server 202 receives a signal that a form has been submitted and is stored on web server 200. When that signal is received, server 105, under the instruction of webform application 202, retrieves some or all of form or form data via HTTP, HTTP, or any other protocol. Such signaling is well understood by those having ordinary skill in the art.

Once received, server webform application 202 causes the processor of computer 1904 to carry out the steps shown in FIG. 1. Briefly, the form is parsed (step 16 of FIG. 1), salespeople are called (steps 18 and 20 of FIG. 1) as facilitated by the PBX of computer 1904, and parsed information is spoken to an answering salesperson (step 22 of FIG. 1). Continuing, the prospect 120 is called (steps 24 and 26 of FIG. 1) at a number indicated in the webform and the salesperson and prospect are directly connected under the control of the PBX of server 1904.

The foregoing detailed description has discussed only a few of the many forms that this invention can take. It is intended that the foregoing detailed description be understood as an illustration of selected forms that the invention can take and not as a definition of the invention. It is only in the claims, including all equivalents, that are intended to define the scope of this invention.

What is claimed is:

1. A method for contacting a prospect or requestor immediately after receiving a request for product information, the method comprising the steps of:
(a) electronically receiving a request for product information;
(b) parsing the request to extract requestor information, wherein the requestor information comprises lead data;
(c) calling a salesperson according to the lead data;
(d) if the salesperson does not answer, repeating (c) for a different salesperson;
(e) if the salesperson does answer, electronically communicating at least some of the lead data to the salesperson;
(f) placing the salesperson on hold;
(g) calling the prospect at a number received from the step of parsing in (c); and
(h) if the prospect answers the call in (g), immediately connecting the salesperson to the requestor, thereby allowing communication between the salesperson and prospect.

2. The method of claim 1 further comprising, before the step of (a), electronically transmitting a product request form to an electronic device of a prospect.

3. The method of claim 2 wherein the step of electronically transmitting a product request form comprises transmitting computer executable code which when executed by a process of the electronic device of the prospect causes a webform to be displayed on the electronic device.

4. The method of claim 1 further comprising querying a customer relationship management database with at least some of the requestor information to receive additional lead data.

5. The method of 4 wherein the step of electronically communicating in (e) comprises electronically speaking at least some of the additional lead data from the customer relationship management database.

6. The method of claim 1 wherein the step of calling a salesperson in (c) comprises:
(1) providing a salesperson database wherein the database comprises, for each salesperson, contact information, an availability status, and additional information about the salesperson; and
(2) selecting a salesperson in the database that is available and according to a comparison between the additional information with the lead data.

7. The method of claim 6 wherein the step of selecting according to the comparison comprises selecting a salesperson based on at least one of: an assignment, a territory, a geography, a product expertise, an experience level, an education level, a language, a gender, an age, and an ethnicity.

8. The method of claim 1 where the step of (c) further comprises simultaneously calling at least one more salesperson, and the step of (e) further comprises disconnecting every salesperson who did not answer.

9. The method of claim 1 wherein the step of electronically communicating in (e) comprises electronically converting text of the lead data into audible speech.

10. The method of claim 1 wherein the step of electronically communicating in (e) further comprises electronically transmitting at least some of the lead data by way of at least one of: computer generated speech, text message, instant message, email, computer executable code displayed in a web browser, a blog, a microblog, and a customer relationship management system user interface.

11. The method of claim 1 wherein the step of electronically communicating in (e) further comprises displaying the lead data on an electronic device of the salesperson.

12. The method of claim 1 wherein the step of calling in (c) further comprises transmitting a caller identification.

13. The method of claim 1 wherein calling the prospect in (g) comprises calling around the same time as placing the salesperson on hold in (f).

14. The method of claim 1 wherein the step of placing the salesperson on hold in (f) comprises connecting the prospect to salesperson so the salesperson can hear the prospect being called in (g).

15. The method of claim 14 further comprising muting a microphone of the salesperson so that the prospect cannot hear the salesperson during the step of (g).

16. The method of claim 1 wherein the step of immediately connecting in (h) comprises removing the hold in (f).

17. The method of claim 1 wherein the step of calling in (c) comprises calling a telephone, calling an electronic device operable to send and receive audio, calling a mobile phone, calling a smartphone, calling a computer via voice over internet protocol.

18. The method of claim 1 further comprising if the prospect does not answer call in (g), rescheduling the call, and repeating the steps of (c) through (h) according the rescheduling.

19. The method of claim 1 further comprising receiving the request via an inbound telephone call.

20. The method of claim 19 wherein the step of parsing in (b) comprises converting speech to text.

21. A system for contacting a prospect or requestor immediately after receiving a request for product information, the system comprising:
means for electronically receiving a request for product information;
means for parsing the request to extract requestor information, wherein the requestor information comprises lead data;
means for calling salespeople according to the lead data until a salesperson answers;
means for electronically communicating at least some of the lead data to the salesperson that answers;
means for placing the salesperson on hold;
means for calling the prospect from the lead data; and
means for, if the prospect answers the call, immediately connecting the salesperson to the requestor, thereby allowing communication between the salesperson and prospect.

22. A method for contacting a prospect or requestor immediately after receiving a request for product information, the method comprising the steps of:
(a) electronically receiving a request for product information by way of a webform;
(b) parsing the webform to extract requestor information, wherein the requestor information comprises lead data;
(c) calling a telephone number of a salesperson according to the lead data;
(d) if the salesperson does not answer, repeating (c) for a different salesperson;
(e) if the salesperson does answer, playing audio of at least some of the least data to the salesperson, wherein the step of playing audio comprises converting text to speech;
(f) placing the salesperson on hold;
(g) calling the prospect at a telephone number received from the step of parsing in (c); and
(h) if the prospect answers the call in (g), immediately connecting the salesperson to the requestor, wherein the step of immediately connecting comprises removing the hold in (f).
